(19) United States
(12) Patent Application Publication
(10) Pub. No.: US 2006/0026610 A1
(43) Pub. Date: Feb. 2, 2006

(54) Optical disk apparatus

(75) Inventors: Keiji Sasao, Tokyo (JP); Shigeo Ohashi, Tokyo (JP); Ikuo Nishida, Tokyo (JP); Hisahiro Miki, Tokyo (JP); Kouhei Takita, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/046,429

(22) Filed: Jan. 27, 2005

(30) Foreign Application Priority Data
Aug. 2, 2004 (JP) 2004-225046

(51) Int. Cl. G11B 7/00; G11B 33/14

(52) U.S. Cl. 720/649

(57) ABSTRACT

An optical disk apparatus includes a spindle motor for rotating the optical disk. The optical pickup device records or reproduces information into/from the optical disk, and a guide shaft 6 guides the optical pickup device in a radius direction of the optical disk. The optical disk is transferred by a disk tray 3. The disk tray and the optical pickup device 7 etc. are contained in a casing 1. A heat storage device 10, a phase of which is changed in an operating state of the optical disk apparatus, is arranged in a casing.

### TECHNICAL FIELD

The present invention relates to an optical disk apparatus for recording/reproducing information by light and an optical pickup device used therefor.

### BACKGROUND OF THE INVENTION

An example of conventional cooling in an optical disk apparatus is disclosed in JP-A-4-254983. In the optical disk apparatus disclosed in JP-A-4-254983, in order to prevent the optical disk from warping by heat generated when driving the apparatus, heat generated at a driving portion is absorbed by a heat pipe being brought into close contact with a chassis to transfer heat. Heat is collected by a heat collector arranged in close proximity to an upper portion of a cartridge case, and is absorbed by the heat pipe arranged in close contact. The heat absorbed by the heat pipes is transferred to a heat sink and dissipated to outside of a casing.

Another example of conventional cooling of a recording/reproducing apparatus is disclosed in JP-A-2003-346371. In the optical disk apparatus disclosed in JP-A-2003-346371, in order to cool a semiconductor laser in a short time, an optical pickup device is moved to an escape position during recording or reproducing, and a housing of the optical pickup device is brought into surface contact with a carbon sheet attached to the main chassis. Thereby, the semiconductor laser is thermally coupled to the main chassis, and the semiconductor laser is cooled.

In the optical disk apparatus disclosed in JP-A-4-254983, the heat pipe is used for cooling. The heat pipe is high in a cooling effect when an object to be cooled is a stationary article. However, transfer of heat is restricted when the optical pickup device moves at a high speed in a radius direction of the disk in seek operation etc. Thus a sufficient cooling effect cannot be obtained by only simply applying the heat pipe.

Further, as a heat conductive member is provided at the escape position of the optical pickup device in the recording/reproducing apparatus disclosed in JP-A-2003-346371, the optical pickup device is moved and brought into contact with the heat conductive member. Therefore, driving force of the optical pickup device is necessary to be increased. Furthermore, in order to cool the optical pickup device efficiently by the heat conductive member, a sectional area of the heat conductive member needs to be enlarged in a vertical direction of heat transfer. However, the more the sectional area of the heat conductive member increases, the more the elasticity of the member becomes large. Thus, it is necessary to further increase the driving force of the optical pickup device.

### BRIEF SUMMARY OF THE INVENTION

The present invention has been developed in view of discrepancy in an aforementioned conventional art, and it is an object of the present invention to reduce a rise in temperature by heat generated inside the optical pickup device moving at a high speed.

According to an aspect of the present invention to achieve the aforementioned object, there is provided an optical disk apparatus for recording/reproducing information into/from an optical disk, comprising: disk rotating means for rotating the optical disk; an optical pickup device for reading or writing information from/into the optical disk; a disk tray for taking out the optical disk; and a casing for accommodating the disk rotating means, the optical pickup device, and the disk tray, wherein heat storage means is mounted in the casing, which is capable of storing heat generated inside the casing, and a phase of which is changed in an operating state of the apparatus.

Additionally, in this aspect, it is preferable that the heat storage means contains a heat storage material therein, and a melting point of the material is lower than a temperature of air inside the casing which is raised by heat generated at the optical pickup device. It is further preferable that the melting point of the heat storage material is in a range of 60° C. to 70° C. In addition, in this aspect, it is preferable that the heat storage means is arranged on a rear side of the casing on a back side in a direction of taking out of the optical disk of the disk tray, or it is kept in a space formed inside the disk tray, or it is arranged at a position corresponding to an outside portion of the disk in a radius direction when the disk is mounted on the disk tray.

Incidentally, the last arrangement of the heat storage means is suitable for a thin model apparatus in which the optical pickup device is provided to be movable in an oblique direction relative to the casing.

According to another aspect of the present invention to achieve the aforementioned object, there is provided an optical disk apparatus for recording/reproducing information into/from an optical disk, comprising: disk rotating means for rotating the optical disk; an optical pickup device for recording or reproducing information into/from the optical disk; guiding means for guiding the optical pickup device in a radius direction of the optical disk; disk transferring means for mounting the optical disk thereon and transferring the disk to the optical disk apparatus; and a casing for accommodating the disk transferring means, the optical pickup device, the disk rotating means and the guiding means, wherein a heat storage material is mounted in the casing, a phase of which is changeable.

Further, in this aspect, it is preferable that the heat storage material is provided in contact with the casing. Alternatively, base means to which the disk rotating means and the guiding means are attached, is provided, and the heat storage material is preferably provided in contact with at least one of the base means, the disk transferring means and the guiding means. Furthermore, a part of the casing may be formed of the heat storage material. Incidentally, in any of the above case, it is desirable that a melting point of the heat storage material is in a range of 60° C. to 70° C.

According to the present invention, in the optical disk apparatus, the heat storage material is provided inside the casing, or a part of the casing is formed of the material, so that heat generated inside the optical disk apparatus is absorbed by the heat storage material as sensible heat and latent heat. Therefore, rise in temperature due to the heat generated inside the optical pickup device can be reduced.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a longitudinal sectional view of an embodiment of an optical disk apparatus according to the present invention.

FIG. 2 is a top view of the optical disk apparatus shown in FIG. 1.

FIG. 3A is a perspective view of another embodiment of an optical disk apparatus according to the present invention.

FIG. 3B is a partially longitudinal sectional view of the optical disk apparatus shown-in FIG. 3A.

FIG. 4A is a perspective view of a further embodiment of an optical disk apparatus according to the present invention.

FIG. 4B is and a partially transverse sectional view of the optical disk apparatus shown in FIG. 4A.

FIG. 5 is a longitudinal sectional view of a still further embodiment of an optical disk apparatus according to the present invention.

FIG. 6 is a top view of a still further embodiment of an optical disk apparatus according to the present invention.

FIG. 7 is a longitudinal sectional view of a still further embodiment of an optical disk apparatus according to the present invention.

FIG. 8A is a longitudinal sectional view and of a still further embodiment of an optical disk apparatus according to the present invention.

FIG. 8B is a front elevation of a heat storage material portion of the optical disk apparatus shown in FIG. 8A.

FIG. 8C is a side view of a heat storage material portion of the optical disk apparatus shown in FIG. 8A.

FIG. 9 is a longitudinal sectional view of a still further embodiment of an optical disk apparatus according to the present invention.

FIG. 10 is a longitudinal sectional view of a still further embodiment of an optical disk apparatus according to the present invention.

FIG. 11 is a top view of the optical disk apparatus shown in FIG. 10.

FIG. 12 is a diagram for explaining a heat transfer route of an optical disk apparatus.

FIG. 13 is a graph for explaining an effect of a heat storage material.

### DETAILED DESCRIPTION OF THE INVENTION

In an optical disk apparatus, a laser light source (semiconductor laser) provided in an optical pickup device is used as a means for reproducing information recorded in an optical disk (hereinafter, referred to as a disk simply) or recording information in the disk. There is a tendency that a rotating speed of the disk is increased, from a request of high density arrangement of information. In order to record or reproduce information stably into/from the disk rotating at a high speed, an output of the semiconductor laser must ensure high power. When the semiconductor laser is operated at the high power, consumed electric power of the semiconductor laser itself increases, and an amount of generated heat thereof increases.

From a characteristic of the semiconductor laser, the more temperature rises, the lower an efficiency for generating the laser beam becomes. In addition, the more temperature rises, the shorter a service life of the semiconductor laser becomes exponentially. Therefore, when a speed of recording or reproducing increases, the rise in temperature of the semiconductor laser increases and the laser is liable to deteriorate.

On the other hand, when the rotating speed of the disk increases, the consumed electric power of a motor for rotating the disk increases. In particular, the more the rotating speed of the disk increases, the more a viscosity resistance against airflow generated due to a rotation of the disk increases. This leads to an increase of the consumed electric power. The electric power consumed in the motor for rotating the disk, is finally converted into heat within the optical disk apparatus to thereby cause to a rise of a temperature inside the apparatus. As a result, the rise in temperature of a semiconductor laser portion is further increased.

In the present invention, heat generated at the inside of the optical disk apparatus in which the disk is rotated at a high speed is effectively absorbed by utilizing a phase change of the heat storage material, thereby reducing the rise in temperature of the semiconductor laser. Hereinafter, several embodiments of the optical disk apparatus according to the present invention will be explained with reference to drawings.

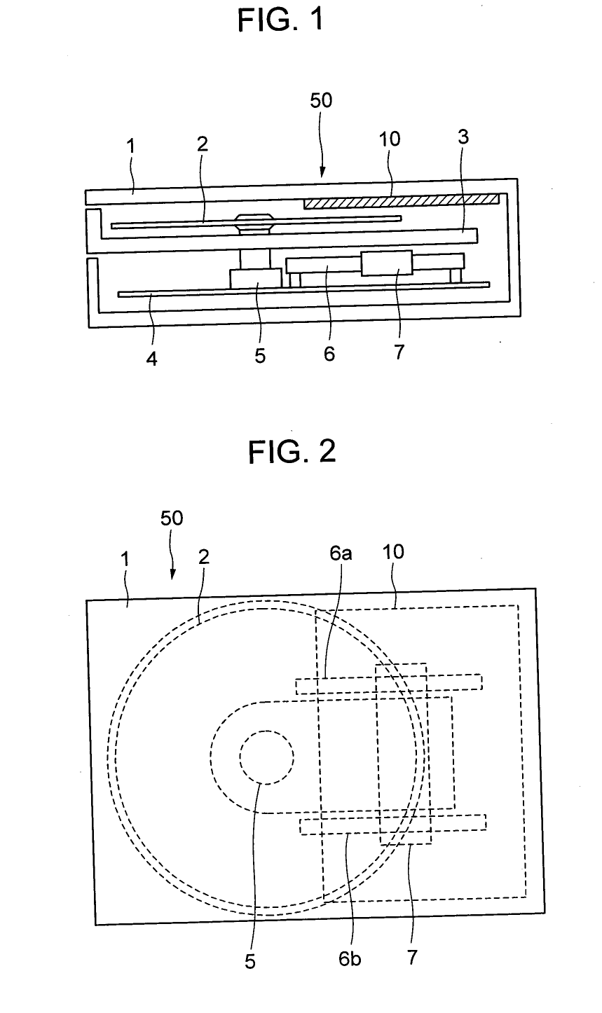

FIG. 1 shows a side view of an embodiment of an optical disk apparatus 50 schematically by removing a cover portion. FIG. 2 shows a top view of the optical disk apparatus 50 shown in FIG. 1. A disk 2 is mounted on a disk tray 3 movably in a depth direction of the optical disk apparatus 50, and is guided into a casing 1 of the apparatus 50. The disk 2 carried in the casing 1 is driven to be rotated by a spindle motor 5.

An optical pickup device 7 is arranged in a back side of the casing beneath the disk 2 carried in the casing 1. Both sides in a width direction of the optical pickup device 7 are held movably in the depth direction by means of a guide shaft 6. The guide shaft 6 and the spindle motor 5 are held by a mechanical chassis 4 via supporting members, illustration of which is omitted. A hole is formed in the disk tray 3 corresponding to a moving range of the optical pickup device 7. A heat storage means 10 is attached in contact with an inner upper face of the casing 1. The heat storage means 10 contains therein the heat storage material, a phase of which is changed when the optical disk apparatus 50 is driven by equal to or less than a rated output. The heat storage means 10 is opposed to the disk tray 3.

In the optical disk apparatus 50 constituted in this manner, the disk 2 serving as an information recording/reproducing medium is mounted at a predetermined position of the disk tray 3 after pulling out the disk tray 3. When the disk tray 3 is transferred into the optical disk apparatus 50, the disk 2 is attached to a rotating shaft of the spindle motor 5 by a means not shown. Then, the spindle motor 5 rotates, and the disk 2 is driven to be rotated. Therewithal, the optical pickup device 7 is guided by means of the guide shaft 6 to move substantially in a radius direction of the disk 2. The optical pickup device 7 is positioned with respect to the disk 2 by a tracking coil or a focusing coil not shown, and information is read or written from/into the disk 2. With this arrangement, the information are recorded or reproduced into/from the disk 2.

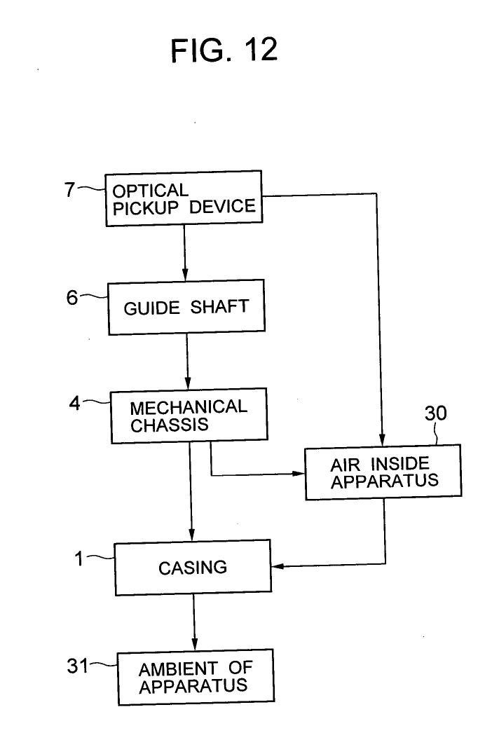

When the disk 2 is driven by the-spindle motor 5 after mounted on the disk tray 3 of the optical disk apparatus 50, the casing 1 is in a substantially hermetically closed state. At this time, heat generated inside the casing 1 is transmitted to an ambient 31 of the optical disk apparatus 50 through a route shown in FIG. 12. The optical pickup device 7 generating the laser beam generates the greatest amount of heat. A part of the heat generated at the optical pickup device 7 is transmitted to the mechanical chassis 4 through the guide shaft 6. A great part of the balance of the heat is transmitted to air 30 existing inside the optical disk apparatus 50.

A part of heat transmitted to the mechanical chassis 4 is further transmitted to the casing 1. The balance of the heat transmitted to the mechanical chassis 4 is transmitted to the air 30 inside the casing 1. Further, all amount of the heat transmitted to the air 30 inside the casing 1 is transmitted to the casing 1, and is finally transmitted to the ambient 31 of the apparatus 50 as the heat of the casing 1. That is, all amount of the heat generated inside the apparatus 50 is transmitted to the ambient 31 of the apparatus 50 through the casing 1.

In consideration of the above heat transmission route, even if an amount of the generated heat at the optical pickup device 7 is not varied, it is possible to lower a temperature of the optical pickup device 7 when a temperature of the casing 1 is lowered. Thus, in the present embodiment, in order to lower the temperature of the optical pickup device 7 to a predetermined temperature or lower, the heat storage means 10 absorbing the heat directly from the air 30 in the casing 1 and from the casing 1 is provided. In addition, the heat storage material whose phase is changeable is selected as the heat storage material which is contained in the heat storage means 10. Absorbing capability thereof is increased through changing the phase of the heat storage material. Accordingly, it is indispensable for the heat storage material to have a melting point at the temperature of the optical pickup device 7 or less. When the heat storage material in the heat storage means 10 melts, the temperature of the casing 1 is kept substantially constant. As a result, the temperature of the optical pickup device 7 is kept at the predetermined temperature or lower.

In the aforementioned embodiment, an example is shown in which one piece of the heat storage means 10 is provided on an inner surface of the casing 1 on a side of the disk 2 in reference to the disk tray 3. However, a plurality of heat storage means may be provided on the same surface. Alternatively, a plurality of the heat storage material may be provided respectively on a plurality of front surfaces or rear surfaces of the casing 1. In the aforementioned embodiment, paraffinic material is used as the heat storage material. However, the heat storage material is not restricted to the paraffinic material, but any material can be used whose phase is changed at an operating temperature of the optical pickup device that is, substantially at a temperature of not less than 60° C. and not more than 70° C. Those material can take the heat from the casing or ambient air at a time of melting.

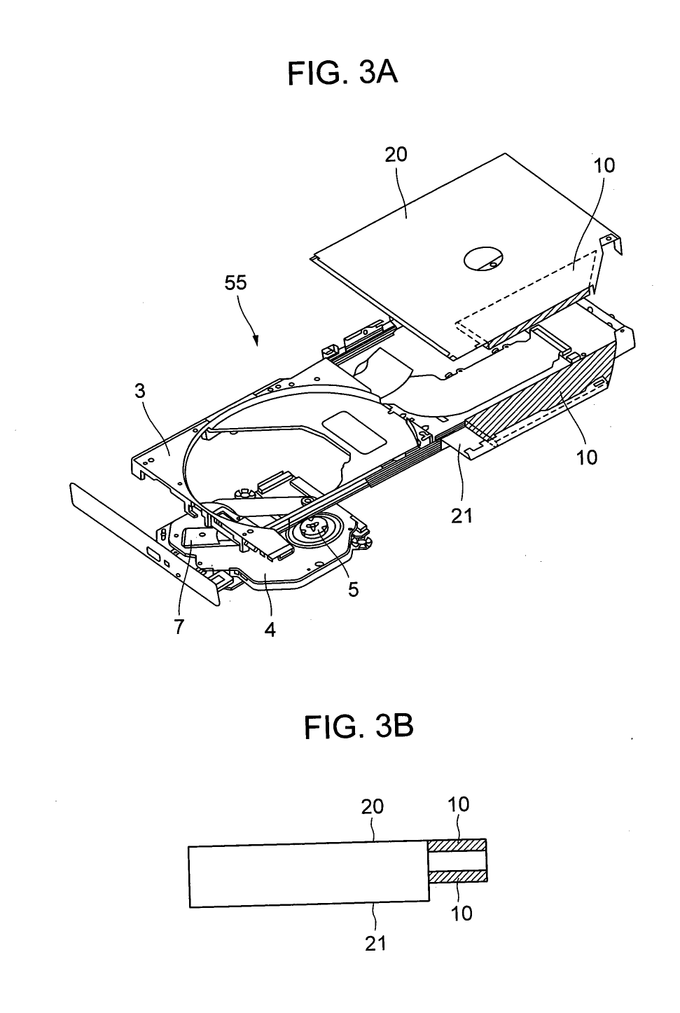

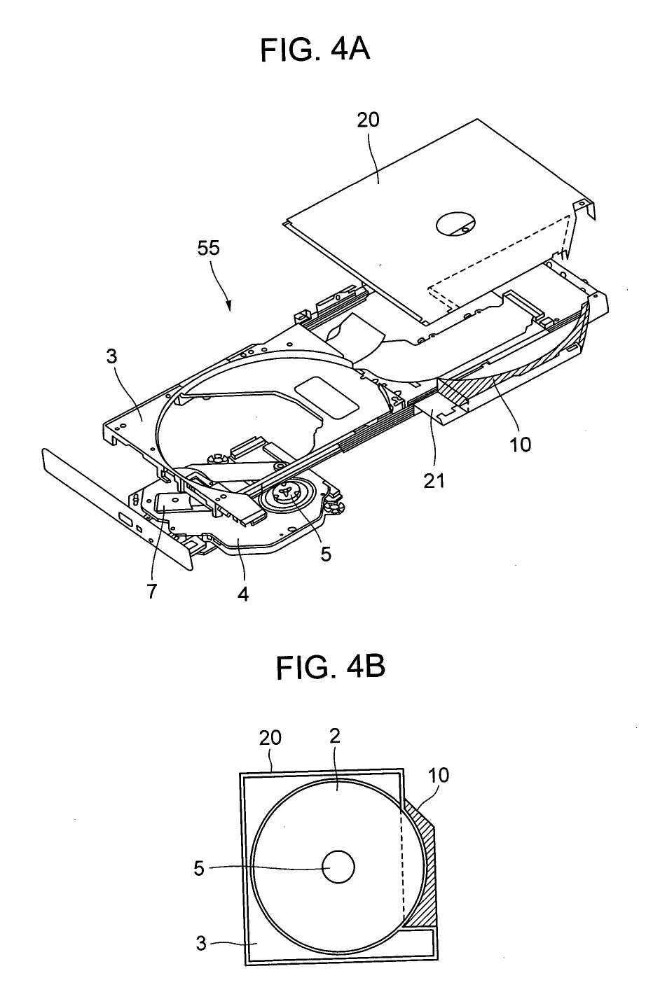

FIGS. 3 and 4 show examples in which heat storage means 10 is attached to a thin model optical disk apparatus 55. The thin model optical apparatus 55 is an apparatus of a specification having a thickness of about 12.7 mm (½ inch) or about 9.5 mm (⅜ inch). FIG. 3A is an exploded perspective view of the thin model optical disk apparatus 55, and FIG. 3B is a partially sectional view of a top cover 20 functioning as a part of a casing 1. Similarly, FIG. 4A is an exploded perspective view of the thin model optical disk 55, and FIG. 4B is a top view of a bottom cover 21 functioning as a part of a casing 1. In FIGS. 3A and 3B, the heat storage means 10 is attached in contact with the bottom cover 21 and the top cover 20 on one side of a width direction. On the other hand, in FIGS. 4A and 4B, the heat storage means 10 is provided only on the bottom cover 21.

In the thin model optical disk apparatus 55, unlike the normal optical disk apparatus 50, there is no space for disposing drive systems of the disk 2 and the optical pickup device 7. Thus, in the thin model optical disk apparatus 55, the optical pickup device 7 is driven by inclining from a direction of taking out of the disk 2. Thereby, a heat generating portion also moves in an oblique direction.

As the thin model optical disk apparatus 55 is formed in this way, the heat storage means 10 is disposed so as to put the disk 2 between the two heat storage means as shown in FIGS. 3a and 3b. Alternatively, the heat storage means 10 is disposed in a space outside the disk position in a radius direction of the disk as shown in FIGS. 4a and 4b. Thereby a restricted space of the thin model optical disk apparatus 55 is effectively utilized. With this arrangement, the thin type optical disk 55 is not required to be large-sized. As well, the temperature of the optical pickup device 7 is kept at the predetermined temperature or lower without interrupting operations of the respective components arranged in the optical disk apparatus 55.

When the heat storage means 10 is arranged as shown in FIGS. 4a and 4b, even if the disk 2 is rotated at a position deviated from the predetermined position for reasons such as a thermal deformation of the disk 2 etc., the disk 2 is in non-contact with the heat storage means 10, so that reliability of the thin model optical disk apparatus 55 is not impaired at all. For example, Paraffin or sodium acetate hydrate, the melting point of which is in a range of an operation temperature of the optical pickup device 7, is used as the heat storage material included in the heat storage means 10. An amount of the heat storage material used is determined by the following Equation.

Recording time per one sheet of disk is about 6 minutes in a case of recording information into a DVD-R disk which is a kind of a recording type of DVD, at a 16 times recording speed. Assuming that an amount of generated heat of the optical disk apparatus 55 at the time of recording is 5 W, an amount of the heat storage material, whose latent heat is 200 J/g, required for absorbing all the generated heat from 4 sheets of the disk in recording becomes,
5 W×6 min.×4 sheets×60*200 J/g=36 g Equation 1

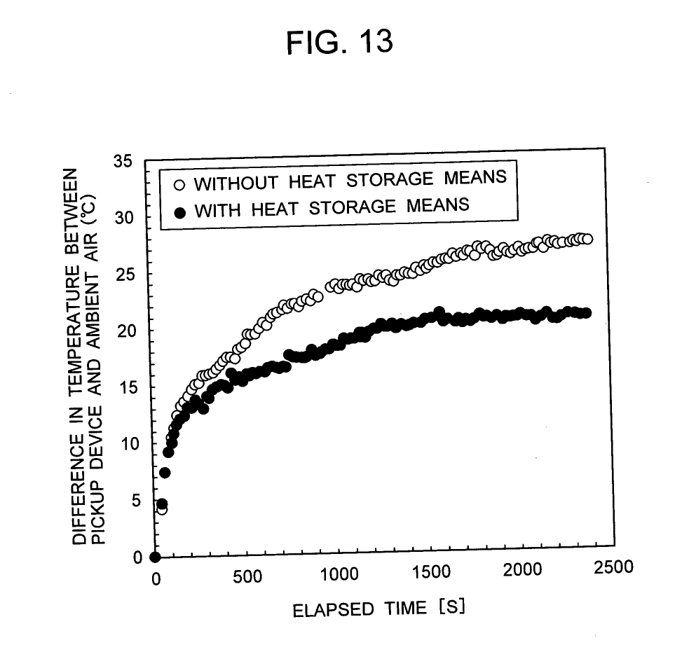

FIG. 13 shows a result of a test using a testing device imitating the optical disk apparatus 50 provided with the heat storage means 10. FIG. 13 shows the test results as to two cases. In one case, the heat storage means 10 is not provided, while in the other case the heat storage means-10 containing the paraffinic material is provided on a surface of the casing. The abscissa axis represents elapsed time from a start of operating the optical pickup device 7, and the ordinate axis represents a difference between the temperature of the optical pickup device 7 and an ambient temperature (that is an atmospheric temperature here) of the imitated optical disk apparatus. According to the test result, when the heat storage means is provided, the rise in temperature of the optical pickup device 7 can be reduced by about 6° C. According to the test, it has become clear that the heat storage means attached to the casing 1 of the optical disk apparatus 50 is effective to lower the temperature of the optical pickup device 7.

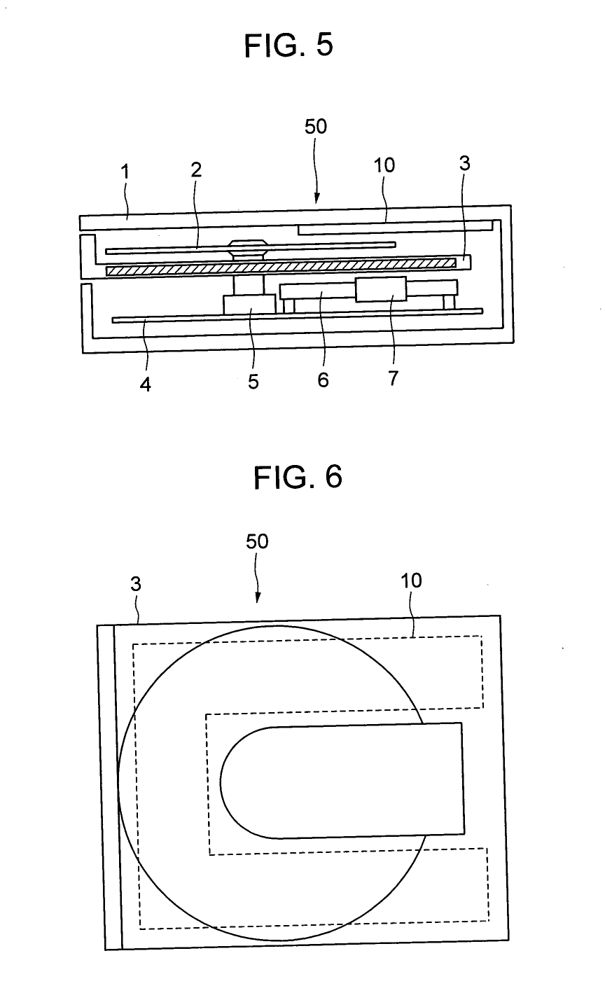

FIG. 5 shows a longitudinal sectional view of a further embodiment of an optical disk apparatus according to present invention. FIG. 6 shows a top view thereof. This embodiment differs from the embodiment shown in FIG. 1 in that the heat storage means 10 is provided inside the disk tray 3, and the disk tray 3 is used to absorb heat. Other arrangement is not changed from that of the embodiment shown in FIG. 1.

When the heat storage means 10 provided inside the disk tray 3 absorbs heat generated at the optical pickup device 7 as latent heat, a temperature of the heat storage means 10 is kept substantially constant. Accordingly, when the melting point of the heat storage means is lowered below the temperature of the air inside the optical disk apparatus 50 (the ambient air), the disk tray 3 operates as a low temperature heat reservoir, and lowers the temperature of the ambient air by absorbing heat therefrom. In this embodiment, the heat storage means 10 is directly sealed in the disk tray 3 to enhance a heat storage effect.

When the rotating speed of the disk 2 increases, a flow speed of the ambient air of the disk 2 induced by the rotation of the disk 2 increases. As a result, convection of air is accelerated on all the surface of the disk tray 3 and a coefficient of heat transfer increases. That is, as the rotating speed of the disk 2 increases, a difference in temperature between the disk tray 3 and the inside of the apparatus 50 decreases. In this embodiment, the disk tray 3 is used as an absorbing source. Therefore, the more the rotating speed of the disk 2 increases, the lower the temperature of the ambient air becomes, if the melting point of the heat storage means 10 is constant.

Heat stored in the heat storage means 10 is dissipated out of the optical disk apparatus 50 each time the disk tray 3 is pulled out of the casing 1. In addition, when the disk tray 3 is pulled out for the purpose of exchanging the disk 2, the disk tray 3 is exposed to ambient air outside the optical disk apparatus 50. At this time, as an ambient temperature is lower than the temperature of the inside of the apparatus 50, the air inside the apparatus 50 is discharged to the outside of the apparatus 50 by an operation to pull out the disk tray 3. Thus, the air temperature inside the apparatus 50 is lowered, as air outside the apparatus having a further low temperature is brought into the apparatus 50. There is a tendency that the more the rotating speed of the disk 2 increases, that is, the more a recording or reproducing speed increases, the more frequently the disk 2 is exchanged, thus, the effect of heat dissipation resulting from the exchange of the disk 2 increases.

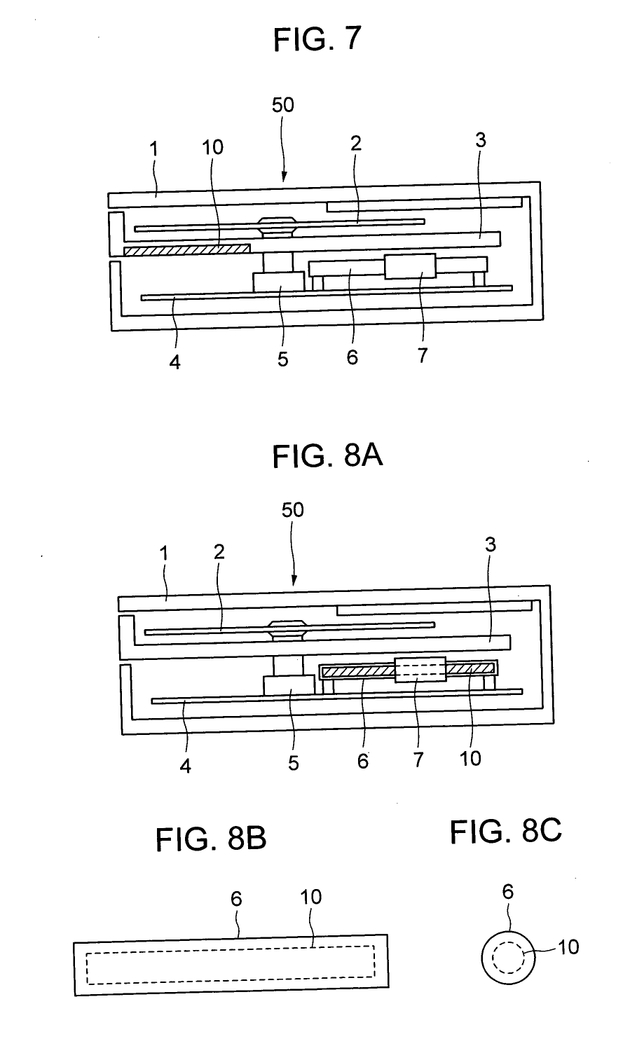

FIG. 7 shows a modified example of the embodiment shown in FIG. 5. In the present modified example, in place of providing the heat storage means 10 inside the disk tray 3, the heat storage means 10 is provided in contact with a bottom surface of the disk tray 3. According to this modified example, as a normally used disk tray can be accepted as the disk tray 3, a structure thereof becomes simple. However, as it is required to pull out the disk tray 3, an opening for pulling out the tray is formed with a sufficient space at a bottom side thereof. Incidentally, in the aforementioned embodiments and the modified example, although only one piece of the heat storage means 10 is provided in the optical disk apparatus 50, it is not necessary to say that a plurality of heat storage means 10 may be provided.

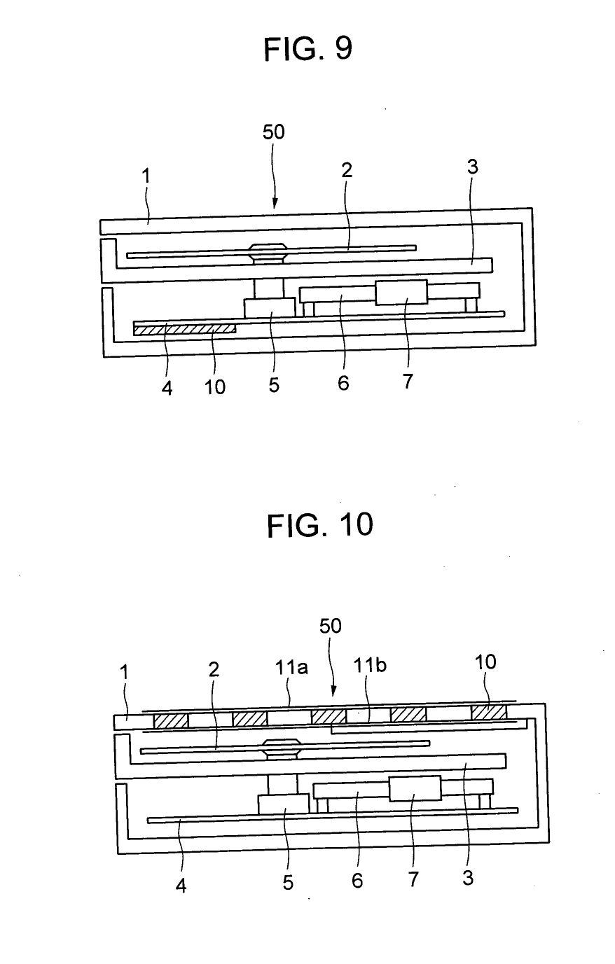

FIGS. 8 and 9 show still further embodiments provided with the heat storage means 10 inside the optical disk apparatus 50. FIG. 8A is a longitudinal sectional view of an optical disk apparatus 50, FIG. 8B is a front view of the heat storage means 10 used for the optical disk apparatus 50, and FIG. 8C is a side view thereof. In this embodiment, the heat storage means 10 is provided inside the guide shaft 6. Arrangement in this embodiment other than the above is not changed from that of the embodiment shown in FIG. 1. As shown in FIG. 12, the heat generated at the optical pickup device 7 is also transmitted to the guide shaft 6. Thus, a temperature of the optical pickup device 7 is lowered by lowering a temperature of the guide shaft 6. The heat storage material as the heat storage means 10 is sealed in the guide shaft 6 which is formed into a hollow shaft. At the time of operation of the optical disk apparatus, the heat storage means 10 absorbs heat from the optical pickup device 7 and the ambient air, and dissipates the heat at the time of a non-operation. When the heat storage material melts at a lower temperature than an operating temperature of the optical pickup device 7, it can absorb the heat due to the phase change thereof.

FIG. 9 shows a still further example in which the heat storage means 10 is provided on the rear surface of the mechanical chassis 4 on a front side of the optical disk apparatus 50. FIG. 9 is a longitudinal sectional view of an optical disk apparatus 50. As shown in FIG. 12, a part of heat generated at the optical pickup device 7 is transmitted to the mechanical chassis 4 through the guide shaft 6. Thus, a temperature of the guide shaft 6 is lowered by lowering a temperature of the mechanical chassis 4. In this embodiment, the rear surface on a front side in which there is comparatively allowance for the space, is utilized for a heat absorbing surface.

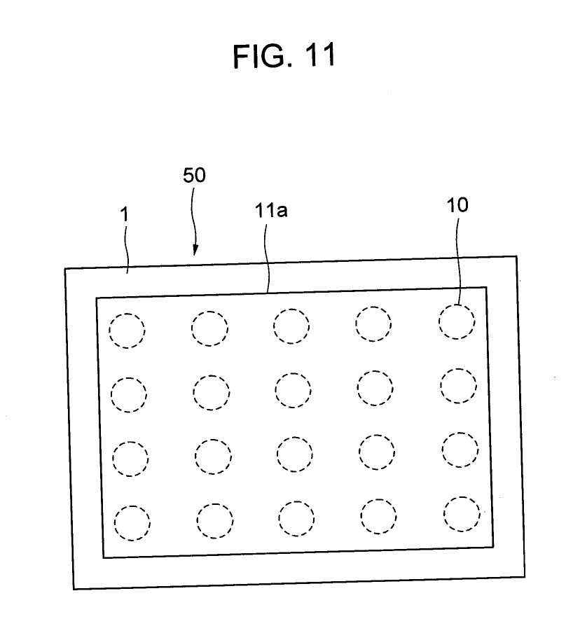

FIGS. 10 and 11 show still further examples in which an upper portion of the casing 1 is utilized for absorbing and transmitting the heat. FIG. 10 is a longitudinal sectional view of an optical disk apparatus 50, and FIG. 11 is a top view thereof. Any projection should not be formed on an upper surface of the casing 1, so that the optical disk apparatus is used satisfactorily even if the apparatus is incorporated into a computer system. For that purpose, in this embodiment a plurality of openings are formed, which penetrate the upper wall of the apparatus 50 from the inner side to the outer side. In these openings the heat storage means 10 are inserted. A sealing member 11a for covering opening portions are provided in contact with the upper outer surface of the casing 1 so as to keep the upper surface being flat. Furthermore, a sealing member 11b for covering the openings is provided on a rear side in contact with an inner surface of a plate member in which the openings are formed.

According to this embodiment, although a part of the casing 1 is utilized for the heat storage means 10, a space inside the optical disk apparatus 50 is not narrowed by the heat storage means 10. Therefore, even in a case where it is difficult to arrange an additional component inside the apparatus such as a small-sized optical disk apparatus, heat can be stored and transferred repeatedly and efficiently by the heat storage means 10. As a result, the temperature of the optical pickup device 7 can be lowered by temporarily storing the heat generated from the optical pickup device 7 at the heat storage means 10, and reliability of the optical pickup device 7 can be improved.

Incidentally, as the openings formed in the casing 1 is covered with sealing members 11a and 11b, even if the heat storage means 10 is melted to become a liquid phase, it is possible to prevent the molten material from leaking to the outside and inside of the optical disk apparatus 50. For this reason, it is not necessary that the heat storage means 10 is sealed in containers etc. individually, thereby assembling workability is improved. Although in this embodiment a form of the opening is selected as a circle, other forms other than circle may be selected. Furthermore, a surface on which the heat storage means is arranged is not restricted to an upper surface of the optical disk apparatus, but a bottom surface or a side face thereof may be selected. However, in the case the upper surface is selected, the highest effect can be obtained.

In the aforementioned respective embodiments, although a case where the heat generated at the optical pickup device is absorbed or stored is referred, it goes without saying that heat generated from other components existing in the casing can be absorbed or stored. Although heat is generated from various semiconductors or others, for example, the heat can be absorbed by the heat storage means through similar route to that generated at the optical pickup device. In addition, in the aforementioned respective embodiments, the paraffinic materials are taken up and explained as the heat storage material. However, the heat storage material is not restricted to the paraffinic material. Any material can be used as the heat storage material as far as the phase of the material is changed at the temperature of the operating temperature of the optical pickup device or less. However, the material which varies in volume remarkably due to the phase change is used, it is necessary that the heat storage means is constituted so as to be tolerant to the variation in volume.

It should be further understood by those skilled in the art that although the foregoing description has been made on embodiments of the invention, the invention is not limited thereto and various changes and modifications may be made without departing from the spirit of the invention and the scope of the appended claims.

1. An optical disk apparatus for recording/reproducing information into/from an optical disk, comprising:
disk rotating means for rotating the optical disk;
an optical pickup device for writing or reading information into/from the optical disk;
a disk tray for taking out the optical disk; and
a casing for accommodating the disk rotating means, the optical pickup device, and the disk tray,
wherein heat storage means is mounted in the casing, the heat storage means being capable of storing heat generated inside the casing, and a phase thereof is changed in an operating state of the apparatus.

2. The optical disk apparatus as set forth in claim 1, wherein the heat storage means contains a heat storage material therein, and a melting point of the heat storage material is lower than a temperature of air in the casing which is raised by heat generated at the optical pickup device.

3. The optical disk apparatus as set forth in claim 2, wherein the melting point of the heat storage material is in a range of 60° C. to 70° C.

4. The optical disk apparatus as set forth in claim 1, wherein the heat storage means is arranged on a rear surface of the casing on a back side in a direction of taking out of an optical disk in the disk tray.

5. The optical disk apparatus as set forth in claim 1, wherein the heat storage means is held in a space formed inside the disk tray.

6. The optical disk apparatus as set forth in claim 1, wherein the optical disk apparatus is a thin model apparatus, wherein the heat storage means is arranged on an rear surface of the casing at a position corresponding to an outside of the disk in a radius direction of the disk on the disk tray, and wherein the optical pickup device is provided to be movable in an oblique direction relative to the casing.

7. An optical disk apparatus for recording/reproducing information into/from an optical disk, comprising:
disk rotating means for rotating the optical disk;
an optical pickup device for recording/reproducing information into/from the optical disk;
guiding means for guiding the optical pickup device in a radius direction of the optical disk;
disk transferring means for mounting the optical disk thereon and transferring the optical disk in the optical disk apparatus; and
a casing for accommodating the disk transferring means, the optical pickup device, the disk rotating means and the guiding means,
wherein a heat storage material is mounted in the casing, a phase of the heat storage material being changeable.

8. The optical disk apparatus as set forth in claim 7, wherein the heat storage material is provided in contact with said casing.

9. The optical disk apparatus as set forth in claim 7, wherein base means is provided, to which the disk rotating means and the guiding means are attached, and wherein the heat storage material is provided in contact with at least one of the base means, the disk transferring means and the guiding means.

10. The optical disk apparatus as set forth in claim 7, wherein a part of the casing is formed of the heat storage material.

11. The optical disk apparatus as set forth in claim 7, wherein a melting point of the heat storage material is in a range of 60° C. to 70° C.
